(19) United States
(12) Patent Application Publication
(10) Pub. No.: US 2016/0092899 A1
(43) Pub. Date: Mar. 31, 2016

(54) SYSTEM AND METHOD FOR USING GAMIFICATION TO IMPROVE ECO-DRIVING BEHAVIOR AND MEASURE FUEL REDUCTIONS

(71) Applicant: Jon Scott OSBERG, Sperryville, VA (US)

(72) Inventor: Jon Scott OSBERG, Sperryville, VA (US)

(21) Appl. No.: 14/496,698

(22) Filed: Sep. 25, 2014

(51) Int. Cl. G06Q 30/02

(52) U.S. Cl. CPC G06Q 30/0207

(57) ABSTRACT

Disclosed herein are systems, methods, and non-transitory computer-readable storage media for improving eco-driving behavior through gamification. Systems receive, at a user device, a fuel-efficiency metric for a vehicle associated with a user of the user device as the vehicle is traveling and identify a fuel-efficiency standard for the vehicle from a standards database. The system also enrolls the user in a game which promotes fuel efficient driving based on the fuel-efficiency metric and the fuel-efficiency standard. When the game indicates a threshold efficiency has been reached, based on the fuel-efficiency metric and the fuel-efficiency standard, the system assigns a reward to the user.

### BACKGROUND

1. Technical Field

The present disclosure relates to improving driver behavior and more specifically to teaching and motivating drivers to reduce fuel consumption through gamification, measuring eco-driving proficiency and fuel reductions, and using that information to identify safe drivers, eco-conscious consumers, and opportunities for leveraging fuel reductions.

2. Introduction

The cars and trucks driven by ordinary people produce carbon dioxide (CO₂) and other emissions, which contribute to greenhouse gases and lead to climate change. According to the Environmental Protection Agency (EPA): “A typical passenger vehicle emits about 5.1 metric tons of CO₂ per year.” The EPA reports that eco-driving can reduce emissions by up to 33% in highway driving. However, a more attainable goal is a 10 to 20% reduction in fuel consumption. Along with vehicle maintenance, the core of eco-driving is anticipation—paying close attention to the roadway environment and to other vehicles. Eco-drivers avoid unnecessary idling and rapid acceleration, and they try to maintain reasonable and consistent speeds in highway driving. Eco-driving requires focus, so it is safer and helps drivers avoid crashes, which are always bad for the environment. Vehicle manufacturers, safety and environmental organizations, and governing bodies all seek to improve driver behavior. Safety and government organizations, for example, continue to research and implement programs to encourage drivers to pay closer attention to the driving task and to avoid using technologies (e.g., cell phones) that take the driver's attention away from the road. In addition, environmental organizations urge drivers to reduce their fuel consumption by keeping their tires properly inflated, driving reasonable speeds, accelerating more gradually, as well as other measures. However, it is difficult to change human behavior by simply telling people how to behave better. Gamification is a more persuasive and fun way to improve driver behavior.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for improving eco-driving behavior through gamification. A system configured according to this disclosure receives, at a user device, a fuel-efficiency metric for a vehicle associated with a user of the user device as the vehicle is traveling. The user device can be a Smartphone, tablet, personal computer (such as a laptop), an on-board diagnostic device/tool, or other mobile device belonging to the user. Alternatively, the user device can be part of the vehicle itself, such as a computer-system built into the vehicle or an aftermarket product that plugs into a vehicle's onboard data port. For example, the user device can be part of the vehicle's built in GPS or other onboard computer system.

The system identifies a fuel-efficiency standard for a vehicle-type associated with the vehicle from a standards database. The standard can, for example, be established by a government agency, such as the Environmental Protection Agency of the United States government, the National Highway Traffic Safety Administration, or another agency. Alternatively, the standard can be established by a manufacturer of the vehicle, an authoritative non-government body, civic associations (such as automotive clubs), or social networks. The system also enrolls the user in a game which promotes fuel efficient driving based on the fuel-efficiency metric and the fuel-efficiency standard. Rather than simply promoting efficient driving, the game compares how efficient the driver is compared to the efficiency standard identified. The game provides results associated with the user playing the game to the system, and when a result indicates a threshold efficiency has been reached, the system provides a reward to the user. Alternatively, the reward can be transferred to another user or entity (e.g., a team or company), based on specific system configuration.

Rewards can include cash, donations to charity, a discount, carbon credits, in-game achievements, pseudo-currency, physical prizes (i.e., a trophy, bumper sticker, tee shirt, or cap), or credit towards additional rewards. An exemplary credit could be awarding the user with points which, when accumulated to a certain amount, provide the user with a larger reward. For example, if the user receives enough “efficient driver” points, the user can be eligible for a gas card which allows them to obtain a certain amount of gasoline for free. Alternatively, enough points can qualify the user for a membership in a more competitive group or game. By participating in the game, the driver is motivated to be a more eco-proficient driver and is trained in how to drive in an eco-friendly fashion.

### BRIEF DESCRIPTION OF THE DRAWINGS

FIG. 1 illustrates an example system embodiment;

FIG. 2 illustrates an exemplary configuration;

FIG. 3 illustrates a first example method embodiment;

FIG. 4 illustrates a second example method embodiment;

FIG. 5 illustrates a first exemplary configuration;

FIG. 6 illustrates a second exemplary configuration.

### DETAILED DESCRIPTION

A system, method and computer-readable media are disclosed which improve eco-driving behavior through gamification. Through competition against a defined fuel efficiency standard, a user seeks not only to drive more efficiently but also to perform well or “win” the game. The game can be a single player game with the player competing against himself or can be a game with additional players, and as the game is played rewards are provided to players based on their driving compared to the standards. Various embodiments of the disclosure are described in detail below. While specific implementations are described, it should be understood that this is done for illustration purposes only. Other components and configurations may be used without parting from the spirit and scope of the disclosure.

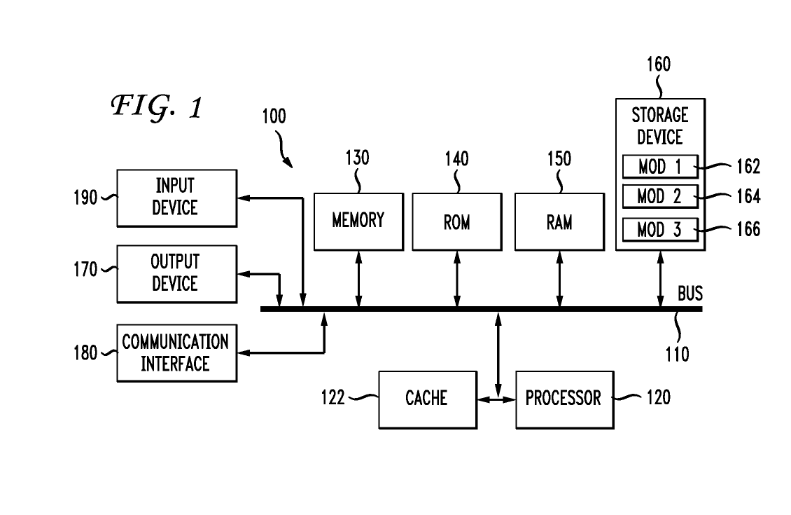

A brief introductory description of a basic general purpose system or computing device in FIG. 1 which can be employed to practice the concepts is disclosed herein. A more detailed description of improving vehicular fuel efficiency will then follow, alongside descriptions of variations as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer-readable storage media provide nonvolatile storage of computer-readable instructions, data structures, program modules and other data for the computing device 100. In one aspect, a hardware module that performs a particular function includes the software component stored in a tangible computer-readable storage medium in connection with the necessary hardware components, such as the processor 120, bus 110, display 170, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 100 is a small, handheld computing device, a desktop computer, or a computer server.

Although the exemplary embodiment described herein employs the hard disk 160, other types of computer-readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations described below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored in other computer-readable memory locations.

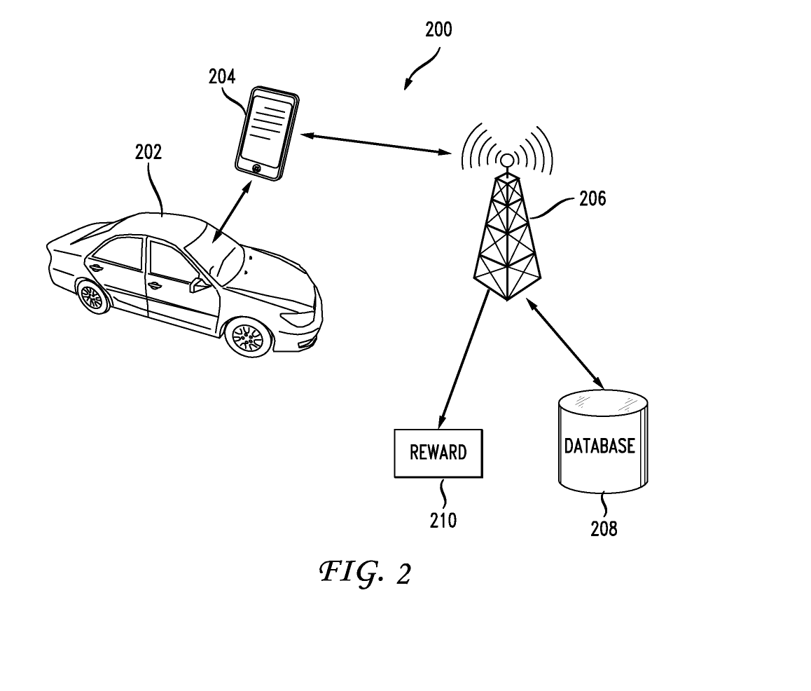

Having disclosed some components of a computing system, the disclosure now turns to FIG. 2, which illustrates an exemplary configuration 200. In this configuration 200, a user is about to drive a vehicle 202. The user's Smartphone 204 (or tablet, computer, or other similar mobile device) connects to the vehicle 202 wirelessly (i.e., via Bluetooth or other wireless connection) or via a wired connection. Alternatively, instead of a Smartphone, the user device 204 can be part of the vehicle 202. In such configurations, the user device 204 could be part of the vehicle's 202 GPS navigation system, an on-board diagnostic device (OBD), or a separate module.

The user device 204 identifies the make and model of the vehicle and, as the user drives the vehicle, receives the fuel-efficiency metric of the vehicle. The fuel-efficiency metric (for example, 25 miles per gallon (MPG)) can be taken over defined periods of time, can be a rolling average, and/or can be a combination of both defined periods and a rolling average. Exemplary time periods during which measurements can be taken include 5 minutes, 15 minutes, an hour, and a day. A rolling time period can be from when the user begins driving the vehicle, an overall vehicle use (that is, from the very beginning of the vehicle's use at 0 total miles), or some combination thereof. In addition, the fuel-efficiency metric could be based on the number of miles traveled. For instance, how efficiently did the driver drive the past 500 miles? Moreover, for both time-period and distance based embodiments, an initiation period might exist, where rolling MPG or other efficiency information is not displayed until a person has driven a predetermined distance or has driven for a predetermined period of time.

The fuel-type can be any fuel which needs to be replenished for continued operation of the vehicle. By far the most common fuel is gasoline, however alternative fuels which equally apply to this disclosure include diesel, hybrid vehicles, bio-fuels, natural gas, electric, and/or any other type of fuel. Using such alternative fuels will generally result in alternative fuel efficiency metrics, for instance using miles per kilowatt hour rather than miles per gallon. However, the systems and methods disclosed herein apply equally to all types of fuel-efficiency.

The user device 204 obtains the vehicle specific fuel-efficiency standard from a database 208. Depending on the configuration, obtaining the standard can occur through a data access point 206, such as a cellular tower, a Wi-Fi receiver, Bluetooth/short field receiver, and/or other communication terminal. Alternatively, rather than accessing a database 208, the fuel efficiency standard can be stored within the user device 202, allowing the user device 204 to receive the fuel efficiency standard without needing to communicate with an access point 206.

As the vehicle 202 is driven, rewards can be granted to the user associated with the user device 204 for meeting predefined requirements. In other words, the user can play a “game” using the fuel efficiency standards and their driving performance, with rewards given based on how well they play the game. For example, the user can be rewarded for attaining a fuel efficiency which is better than the fuel efficiency standard. For example, the United States Environmental Protection Agency could set a fuel-efficiency standard for the make, model, and/or type of vehicle, and that fuel-efficiency standard could be downloaded or otherwise received from a database 208. As the driver of the vehicle 202 attains or exceeds the fuel-efficiency standard, the user associated with the user device can be identified as an eco-conscious consumer and can receive a reward 210, such as carbon credits, cash rewards, donations to charity, discounts, coupons, “achievements” or “trophies” (such as Xbox live achievements), and/or points.

The user device 204 can have a user profile which stores specific information about the user, the user's driving performance, the user's game status, challenges associated with the game, etc. The user profile can also be linked to the vehicle identification number (VIN) of the vehicle 202 and to the EPA fuel efficiency rating of the vehicle 202. The standard can become part of the user profile, for as long as the VIN does not change, and that standard can be in used as part of the game. Standards may also be set dynamically, based on the ongoing driving behavior of other drivers. For instance, the same model or class of vehicle competing in a contest whereby the standard evolves based on the behavior of drivers with the same model or class of vehicle. Standards may also be set by having a user or group of users compete against their own or another user or a group's past performance.

In various configurations, the user and/or driver can be on a team, or in a group, where the user can be ranked and otherwise compete against and/or work with the other players in the game. As an example, the user could be ranked, within the group, based on how the user drove compared to the fuel-efficiency standard for their vehicle. Therefore “Bob,” who drives a sports utility vehicle with relatively poor fuel efficiency, but drives the vehicle very efficiently and surpasses the fuel-efficiency standard set by the EPA (or another authoritative body) for that vehicle, could be ranked higher than “Jim” who drives a smaller vehicle with relatively good fuel efficiency, but drives the vehicle very inefficiently and does not meet the fuel-efficiency standard for his vehicle. In other configurations, the users/players can have scores combined together, such that a team of users playing the game can pool scores and accomplishments together for competitions, rewards, and/or other aspects of game play. For example, if a family or group of friends all combine scores, they can be eligible for larger rewards or prizes than any individual competitor.

Membership in a group or team can be a choice or can be automatic as part of the game. For example, enrollment in the game can automatically group the user with other individuals nearby, or can ask the user to choose an existing group or form their own group. The enrollment can be free or can cost a fee. In addition, the fee or free nature can change based on the specific group requested and/or the experience/points previously given to the user. For example, if the user has completed a certain number of challenges, membership in a particular team might be free and/or subsidized, whereas if the user has not completed enough challenges joining the team, group, and/or competition can cost a fee. In addition, certain groups, teams, and/or competitions can require various challenges be met before allowing a user to join. For example, a user might need to accomplish driving at 110% of the fuel-efficiency standard for 10 hours before being allowed to join a group, team, and/or competition. Specific groups, teams, and/or competitions can have additional rewards and/or prizes not available to individuals who are not members of groups or teams, or who have not chosen to compete in specific competitions.

The system can sum or average eco-driving proficiency and/or fuel saved over a period of time, such as 5 minutes, an hour, a day, a week, or a month. To perform the summation or averaging, the system can collect data samples used to calculate eco-driving proficiency/fuel saved during the period of time, where the data samples can be collected periodically or continuously while driving the vehicle. For example, if the system is averaging eco-driving proficiency over a 5 minute period, the system may collect data every 30 seconds for the 5 minutes, where the data indicates a distance traveled and fuel consumed within that 30 seconds. Such data collection can be used to give immediate and long-term feedback regarding how efficiently the user is driving. Likewise, rewards can be granted immediately upon attaining a game objective (i.e., drive 50 miles at an efficiency 15% over the fuel-efficiency standard) or periodically (i.e., a weekly reward if a goal is accomplished, a monthly goal, etc.).

In addition to driving with a fuel efficiency at or above the fuel-efficiency standard set by an organization (such as the EPA), rewards can be provided for good driving practices, such as minimal hard braking and hard acceleration, maintaining an efficient engine, etc. Specific challenges can therefore include both fuel-efficient driving and good driving habits. Rewards can be directly tied to the challenges completed or can be cumulative. For example, a user may receive an “achievement” for driving 15 hours at 115% of the fuel-efficiency standard, however the “achievement” alone is only for bragging rights.

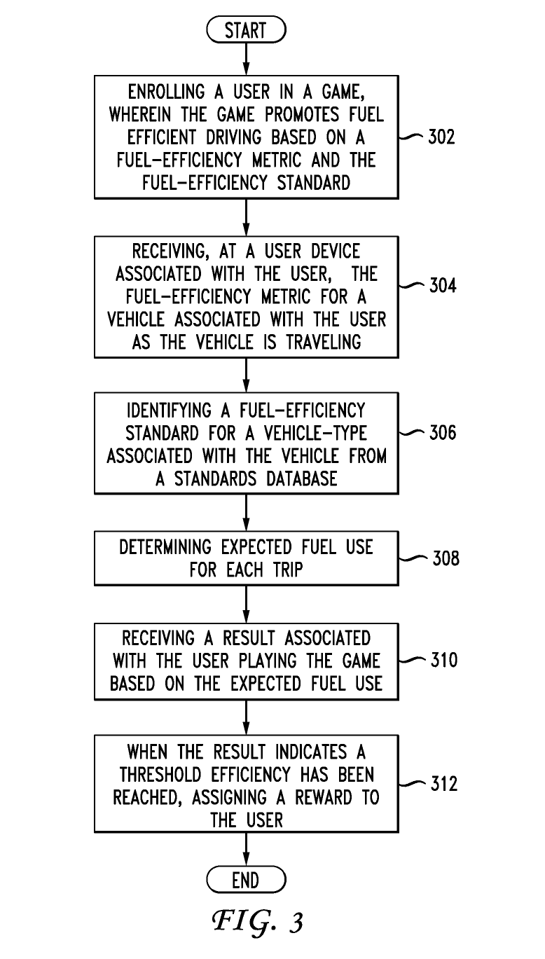

Having disclosed some basic system components and concepts, the disclosure now turns to the exemplary method embodiment shown in FIG. 3. For the sake of clarity, the method is described in terms of an exemplary system 100 as shown in FIG. 1 configured to practice the method. The steps outlined herein are exemplary and can be implemented in any combination thereof, including combinations that exclude, add, or modify certain steps.

The system 100 enrolls the user in a game, wherein the game promotes fuel efficient driving based on a fuel-efficiency metric and a fuel-efficiency standard (302). The game can be played as a single-player attempting to meet specified challenges or to achieve various accomplishments, or the game can be played with and/or against other users organized into groups and teams. Enrollment in the game can be free or can require payment, and after a first time enrolling the membership in the game can be verified upon subsequent enrollments. The system 100 receives, at a user device (such as a cell phone, smart phone, tablet computer, or other electronic device) the fuel-efficiency metric for the vehicle associated with a user of the user device as the vehicle is traveling (304). The vehicle can be a passenger vehicle or a commercial vehicle, which the user is driving. The fuel-efficiency metric can vary based on the type of fuel being used, whether gasoline, diesel, electricity, a biofuel, or any other type of fuel. The system 100 identifies a fuel efficiency standard for a vehicle-type, or a specific vehicle model, associated with the vehicle from a standards database (306). For example, if the United States Environmental Protection Agency set fuel-efficiency standards for mid-size pickup trucks, and the vehicle were of the mid-size pickup truck “type,” the system 100 would identify the EPA standard as the standard associated with the vehicle. Likewise, if the vehicle were a mid-size sedan, an SUV, a mini-van, or any other type of vehicle, the system 100 can identify the fuel-efficiency standard associated with that type of vehicle.

The system 100 determines an expected fuel use for each trip (308) and receives a result associated with the user playing the game based on the expected fuel use (310). The result can be provided to the user or to the user device periodically (such as every 5 minutes while driving), as a “final” result (such as when the trip ends and the user stops driving), and/or as a historical record of a trip taken in the past. The result(s) can be in a particular format for the user device or can be in a text format. In addition, the result(s) can indicate what the user did to achieve those results, what the user should do to achieve different and/or better results, a range/class of results (i.e., A, B, C; top 5%, top 10%, bottom 10%), and future challenges which might be applicable to the user.

When the result indicates a threshold efficiency has been reached, the system 100 assigns a reward or credit to the user (312). Exemplary rewards include game points; cash; donations to charity; carbon credits; achievements; invitations to teams, groups, competitions, and/or challenges; discounts; and in-game currency. Through playing the game, the system 100 identifies eco-conscious drivers from among active players, members of a team, members of a group, previous players, geographically co-located players (such as players in the same city or state), family members, civic organization, and/or other group of players. As gameplay continues, the groups can evolve, changing to best reflect current goals of the user(s), or game designers, whether those goals include competing against one another, competing against the set fuel-efficiency standards, or trying to achieve personal goals.

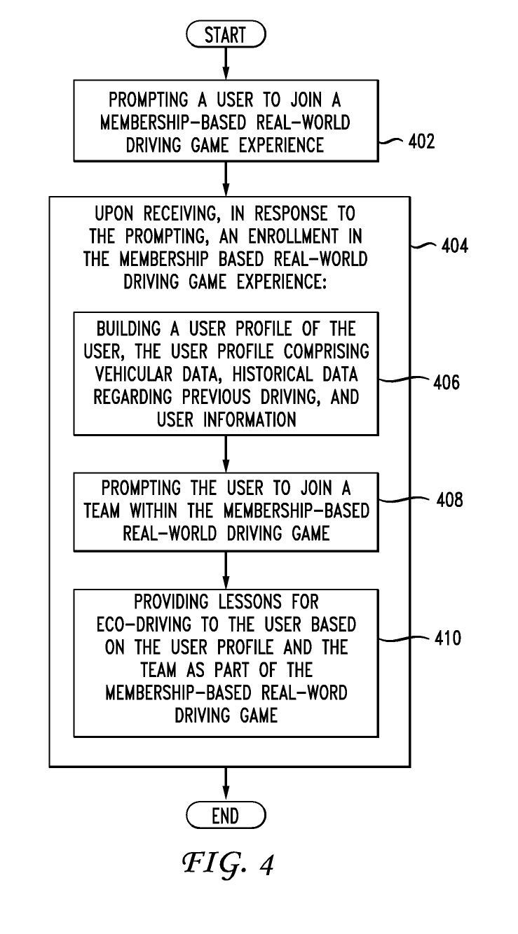

FIG. 4 illustrates an alternative method embodiment which also uses a system as described in FIG. 1. In this example, the system 100 prompts a user to join a membership-based real-world driving game experience (402). When the system 100 receives, in response to the prompting, an enrollment in the membership based real-world driving game experience (404), the system builds a user profile of the user, the user profile comprising vehicular data, historical data regarding previous driving, and user information (406). The system further prompts the user to join or form a team within the membership-based real-world driving game (408) and provides lessons for eco-driving to the user based on the user profile and the team as part of the membership-based real-world driving game (408). In this way, the system can use gamification to educate drivers how to become more fuel efficient drivers. The education can include information on vehicle maintenance, driving style, and crash avoidance. In addition, the system 100 can provide to the user eco-driving knowledge quizzes and a venue for team leaders, teammates, and all players to discuss eco-driving. The system 100 can also provide feedback on miles per gallon (i.e., fuel efficiency) based on speed range using unique charts, and/or provide feedback on good/bad driving events which occur. One example of a unique chart can be a chart showing the fuel efficiency for one or more vehicles within speed ranges, thereby informing a user of the speeds which are not fuel efficient for their particular vehicle. During the game, the system 100 can present the chart to the user to teach the user about fuel efficient driving speeds and/or provide information for the user which can be used to improve fuel efficiency.

Another embodiment uses gamification to motivate drivers to eco-drive. Such an embodiment harnesses voluntary action (such as gamification) to motivate players, and can offer repeated cycles of competition to keep players interested (i.e., monthly competitions). Such an embodiment can also provide ways for users to communicate with teammates and motivate each other. In addition, ongoing statistical feedback can be provided, such as money saved by eco-driving, overall game score and components, updates about the “carbon Carprint™” of the vehicle being driven, as well as rewards such as prizes, positive feedback (e.g., tweets), leader awards, and/or charitable donations.

In another possible embodiment, the system 100 uses gamification to determine eco-driving proficiency. In such an embodiment, the game is used as a yardstick for measuring eco-driving proficiency as follows:
ACTUAL TRIP MPG: vehicle miles traveled (VMT)/amount of fuel used
EXPECTED TRIP MPG using the EPA MPG ratings as an example, as follows:
   Acquiring data on speed, distance traveled, and fuel used at regular intervals (e.g., approximately once per second) for each trip driven
   Apportioning VMT into rating categories (e.g., EPA ratings) based on speed (e.g., if speed<46 MPH, VMT=city; if speed>=46 MPH, VMT=highway)
   Apportioning fuel used into the same EPA rating categories based on speed (e.g., if speed<46 MPH, fuel used=city; if speed>=46 MPH, fuel used=highway)
      a. Summing distance traveled for first EPA rating category (e.g., city driving)
      b. Summing distance traveled for second EPA rating category (e.g., highway driving)
      c. Summing distance traveled for other EPA rating categories, as appropriate
      d. Summing fuel used for first EPA rating category (e.g., city driving)
      e. Summing fuel used for second EPA rating category (e.g., highway driving)
      f. Summing fuel used for other EPA rating categories, as appropriate
   Calculating MPG for first EPA rating category (a/d)
   Calculating MPG for second EPA rating category (b/e)
   Calculating MPG for other EPA rating categories (c/f)
   Calculating combined expected Trip MPG ((# city miles/# total miles)*EPA rating for city MPG+((# hwy miles/# total miles)*EPA rating for hwy MPG)
   If actual MPG<=expected MPG, EPA expected TRIP ECO-SCORE=null
   If actual MPG>expected MPG, calculate TRIP ECO-SCORE (Actual Trip MPG minus EPA expected Trip MPG)/EPA expected Trip MPG)=N percent higher than expected
   Calculating eco-driving proficiency as follows
      ECO-DRIVING PROFICIENCY=Average of weighted sums of all Trip Eco-Scores, where trips are weighted by VMT (i.e., longer trips have more weight than shorter trips): Σ(Trip Eco-Score*Trip VMT)/Total VMT.

Therefore, eco-driving proficiency is the average percentage above EPA expected MPG for N trips in which Actual MPG>Expected MPG. It is noted that trips in which Expected MPG>Actual MPG are excluded from the average due to the assumption that were it not for the game, all Actual MPG would be less than Expected MPG on all trips. It is further noted that another reason for excluding trips in which expected MPG>actual MPG is that the game can encourage players to eco-drive through positive reinforcement. Notwithstanding this example where trips in which actual MPG is lower than expected MPG are excluded from the eco-proficiency score, this should not be viewed as a limiting factor. Once the actual MPG is recorded and a standard benchmark has been chosen, other formulas for determining eco-driving proficiency are possible.

In another embodiment, the system 100 uses gamification to determine reductions in fuel use. In such an embodiment, the game is used as a yardstick for measuring fuel reductions as follows:
FUEL REDUCTION=Sum of Expected Fuel Use minus Sum of Actual Fuel Use for N trips, where:
   EXPECTED FUEL USE=VMT/Expected MPG (for each trip)

Yet another embodiment uses eco-driving proficiency to identify low-risk/high-risk drivers. In such a configuration, the system uses eco-driving proficiency alone or combined with other metrics to identify safe drivers. In particular, the system combines the eco-driving score with other measures including: hard braking, number of hours driving, time driving between midnight and 4 am, top speeds in relation to speeds of other contestants in the same region, etc. The system then combines the various measures into a safety score, and uses the safety score to rank and identify safe drivers. In such a configuration, the players in a game can be “graded” based on their safety level.

Another embodiment uses fuel saved/CO₂ averted with the purpose of documenting and securing funding, for instance by selling carbon credits or raising revenue based on the number of tons of CO₂ reduced. Such an embodiment can calculate actual fuel used, the expected fuel use, the fuel saved (i.e., if Actual MPG>Expected MPG then fuel saved=Expected fuel minus Actual fuel used), and track CO₂ reductions. For example, using gallons of fuel as the metric, one can calculate the actual gallons saved for a trip as disclosed above and the system 100 can then take the sum of gallons saved on all trips for an individual or group of players and calculate the total number of tons of CO₂ not emitted, which can be used for raising revenue, for instance by raising revenue based on the number of tons of CO₂ averted. Note that each gallon of gasoline burned produces approximately 19.5 pounds of CO₂.

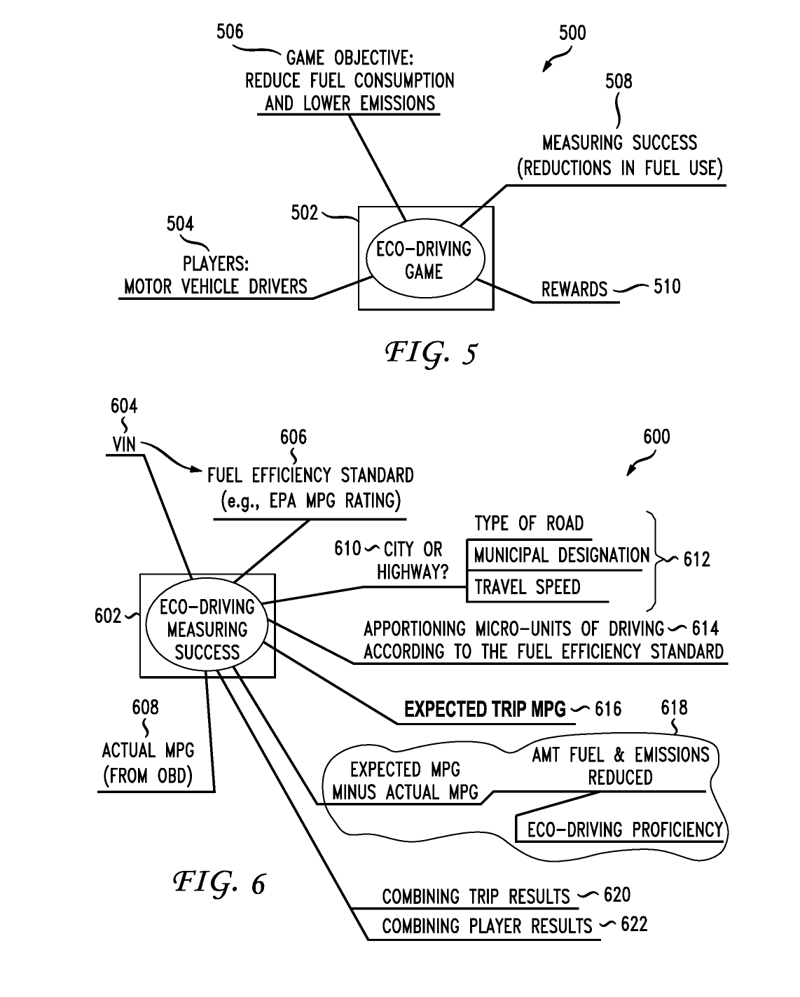

FIG. 5 illustrates a first exemplary configuration 500. In this configuration 500 the eco-driving game 502 identifies the players (motor vehicle drivers) 504 and an objective of the game (reduce fuel consumption and lower emissions) 506. The game 502 also identifies how success will be measured (such as by reductions in fuel use) 508. Based on real-world performance and action, the eco-driving game 502 can identify and reward users 510.

FIG. 6 illustrates a second exemplary configuration 600. This configuration illustrates one way in which success at eco-driving can be measured 602. In this configuration, the system uses the Vehicle Identification Number (VIN) 604 in conjunction with a fuel-efficiency standard (such as the EPA MPG rating) for that vehicle 606. The system also uses an expected trip MPG 616 based on the type of driving 610 during a trip. Factors 612 which can affect the type of driving include the type of road, municipal designation, and travel speed. Actual MPG 608 is received from the vehicle's on-board data port and apportioned into micro-units of driving according to the fuel efficiency standard 614. By comparing the expected MPG to the actual MPG for each trip, and determining the amount of fuel and emissions reduced, eco-driving proficiency can be calculated 618. In addition, the trip results can be combined 620 over time or over multiple trips, and individual player results 622 can likewise be combined over time or over multiple trips.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply to any form of gamification aimed at teaching or motivating users to reduce fuel consumption by eco-driving, any kind of standard for measuring expected fuel use and eco-driving proficiency, any form of using eco-driving proficiency and/or fuel reductions to identify low risk or eco-conscious drivers, and any form of using eco-driving proficiency and fuel reductions to raise revenue. Various modifications and changes may be made to the principles described herein without following the example embodiments and applications illustrated and described herein, and without departing from the spirit and scope of the disclosure.

We claim:

1. A method comprising:
enrolling a user in a game, wherein the game promotes fuel efficient driving based on a fuel-efficiency metric and the fuel-efficiency standard;
receiving, at a user device associated with the user, the fuel-efficiency metric for a vehicle associated with the user as the vehicle is traveling;
identifying a fuel-efficiency standard for a vehicle-type associated with the vehicle from a standards database;
determining expected fuel use for each trip;
receiving a result associated with the user playing the game based on the expected fuel use; and
when the result indicates a threshold efficiency has been reached, assigning a reward to the user.

2. The method of claim 1, wherein the game further comprises teaching the user about fuel efficient driving using a chart, the chart comparing fuel-efficiency within speed ranges.

3. The method of claim 1, wherein the reward is a donation to charity.

4. The method of claim 1, wherein the game allows the user to view their own fuel-efficiency compared to other users.

5. The method of claim 4, further comprising rewarding the user based on comparisons to other users.

6. The method of claim 4, further comprising grouping the user into a team with the other users.

7. The method of claim 1, wherein enrolling of the user in the game further comprises:
obtaining a membership in the game upon a first usage; and
verifying the membership upon subsequent usage.

8. The method of claim 1, wherein the fuel-efficiency standard is defined by one of an authoritative body of the United States government, a consumer body, and a private sector organization.

9. The method of claim 8, wherein the expected fuel use for a trip is estimated based on the type of driving.

10. The method of claim 1, wherein micro-units of trip data are apportioned, based on vehicle speed, into at least two types of driving.

11. A system comprising:
a processor; and
a computer-readable storage medium having instructions stored which, when executed by the processor, cause the processor to perform operations comprising:
receiving, at a user device, a fuel-efficiency metric for a vehicle associated with a user of the user device as the vehicle is traveling;
identifying a fuel-efficiency standard for a vehicle-type associated with the vehicle from a standards database;
enrolling the user in a game, wherein the game promotes fuel efficient driving based on the fuel-efficiency metric and the fuel-efficiency standard;
receiving a result associated with the user playing the game; and
when the result indicates a threshold efficiency has been reached, assigning a reward to the user.

12. The system of claim 11, wherein the game further comprises teaching the user about fuel efficient driving using a chart, the chart comparing fuel-efficiency within speed ranges.

13. The system of claim 11, wherein the reward is a donation to charity.

14. The system of claim 11, wherein the game allows the user to compare their fuel use and reductions to other users.

15. The system of claim 11, wherein the game allows the user to compare their eco-driving proficiency to other users.

16. The system of claim 11, wherein the game provides scientific data on fuel reductions

17. The system of claim 15, the computer-readable storage medium having additional instructions stored which, when executed by the processor, result in operations comprising rewarding the user based on interactions with the other users.

18. The system of claim 15, the computer-readable storage medium having additional instructions stored which, when executed by the processor, result in operations comprising grouping the user into a team with the other users.

19. The system of claim 15, the computer-readable storage medium having additional instructions stored which, when executed by the processor, result in operations comprising identifying, within a group comprising the user and the other users, eco-conscious drivers.

20. A computer-readable storage device having instructions stored which, when executed by a computing device, cause the computing device to perform operations comprising:
receiving, at a user device, a fuel-efficiency metric for a vehicle associated with a user of the user device as the vehicle is traveling;
identifying a fuel-efficiency standard for a vehicle-type associated with the vehicle from a standards database;
enrolling the user in a game, wherein the game promotes fuel efficient driving based on the fuel-efficiency metric and the fuel-efficiency standard;
receiving a result associated with the user playing the game; and
when the result indicates a threshold efficiency has been reached, assigning a reward to the user.
